(19) United States
(12) Patent Application Publication
(10) Pub. No.: US 2010/0304230 A1
(43) Pub. Date: Dec. 2, 2010

(54) FUEL PROCESSING SYSTEM FOR DESULFURIZATION OF FUEL FOR A FUEL CELL POWER PLANT

(76) Inventor: Roger R. Lesieur, Enfield, CT (US)

Correspondence Address: Malcolm J Chisholm, P O Box 278, Lee, MA, 01238, US

(21) Appl. No.: 12/734,834

(22) PCT Filed: Dec. 17, 2007
(86) PCT No.: PCT/US2007/025769

§ 371 Date: May 26, 2010

(51) Int. Cl. H01M 8/06

(52) U.S. Cl. 429/410

(57) ABSTRACT

A fuel processing system (14) removes sulfur from fuel cell fuels such as ethanol and methanol. The system (14) directs the fuel through a fuel vaporizer (26), reformer (32), carbon monoxide conversion station (44,48) and through a sulfur scrubber station (52). The fuel is then directed into an anode flow field (16) of a fuel cell (12) of a fuel cell the power plant (10). By converting the carbon monoxide prior to removing sulfur from the fuel, no carbon monoxide is available to form gaseous carbonyl sulfide within the sulfur scrubber station (52). Because no carbonyl sulfide is formed, sulfur adsorption material within the scrubber station (52) may adsorb elemental sulfur from the fuel equal to between about fifteen percent and sixty percent of a weight of the sulfur adsorption material so that regeneration of the sulfur adsorption material is not necessary.

### TECHNICAL FIELD

The present disclosure relates to fuel cells that are suited for usage in transportation vehicles, portable power plants, or as stationary power plants, and the disclosure especially relates to a system and method of desulfurization of fuel for a fuel cell power plant.

### BACKGROUND ART

Fuel cells are well known and are commonly used to produce electrical current from hydrogen containing reducing fluid fuel and oxygen containing oxidant reactant streams to power electrical apparatus such as transportation vehicles. As is well known in the art, a plurality of fuel cells are typically stacked together to form a fuel cell stack assembly which is combined with controllers and other components to form a fuel cell power plant. In fuel cells of the prior art, it is well known that fuel is often processed through a reformer and the resulting reformate fuel flows from the reformer through one or more fuel treatment stations into and through anode flow fields of the fuel cells of the stack. An oxygen rich reactant simultaneously flows through a cathode flow field of the fuel cell to produce electricity. Unfortunately, known fuels for fuel cells, such as reformate fuels from reformers, frequently contain contaminants especially sulfur, which is detrimental to the performance of the fuel cell.

### SUMMARY

It is increasingly common to consider renewable energy sources such as ethanol or methanol as a fuel source for a reformer of a fuel cell power plant. Unfortunately, there are no known methods of efficiently desulfurizing ethanol or methanol. Where methanol has been utilized for experimental fuel cell power plants powering urban buses, only a very expensive, ultra-pure grade of methanol may be used to minimize sulfur contamination of the fuel cells. Similarly, the renewable fuel ethanol also contains small amounts of sulfur (e.g., 1-2 parts per million (“PPM”)). Further complicating use of such fuels is a requirement that ultra-pure, or extremely low sulfur content fuels, must be transported to fuel cell power plants in dedicated fuel delivery systems to avoid sulfur contamination from high-sulfur content fuels transported in non-dedicated fuel delivery systems.

One effort at desulfurization of fuel for a fuel cell power plant is disclosed in U.S. Pat. No. 6,610,265 that issued on Aug. 26, 2003 to Szydlowski et al., which patent is owned by owner of all rights in the present invention. Szydlowski et al. shows a complex system and method that includes parallel desulfurization beds through which the fuel flows. While one desulfurization bed is being utilized to desulfurize a reformate fuel, the other desulfurization bed is being regenerated by a gas stream containing carbon monoxide.

In the system and method disclosed in Szydlowski et al. a reformate fuel flows first through a sulfur scrubber station that includes the two beds, and then through an ammonia removal bed and then through a carbon monoxide reduction station to minimize the amount of carbon monoxide within the fuel. The fuel is then directed into an anode flow field of a fuel cell. The sulfur scrubber station or bed converts hydrogen sulfide in the gaseous fuel stream to elemental sulfur through the Claus reaction with an addition of a small amount of atmospheric oxygen. The elemental sulfur then precipitates out of the gaseous stream onto a surface of a sulfur adsorption material in the scrubber. Once sulfur accumulates on the adsorption material surfaces the carbon monoxide in the fuel stream begins to react with the sulfur to form carbonyl sulfide (COS) which is carried to the anode, poisoning the anode. As a result, the fuel stream must be switched to a parallel bed to avoid contamination of catalysts of the fuel cell by the COS flowing with the fuel. The sulfur scrubber bed with the accumulated elemental sulfur can be regenerated by directing a gaseous stream containing at least one percent by volume carbon monoxide. The carbon monoxide converts elemental sulfur to gaseous carbonyl sulfide (COS), which is then directed to flow out of the bed.

While the Szydlowski et al. desulfurization system and method achieves acceptable results by producing exit sulfur levels of less than ten parts per billion, the system is very complex and therefore involves substantial cost in manufacture, assembly and operation, and necessarily requires a large volume of the power plant to house all if its components. This is especially important for any types of mobile fuel cell power plants where space and weight are critical to a successful design. Consequently there is a need for a system and method of desulfurizing fuel for a fuel cell power plant that minimizes manufacture, assembly and operating costs, and that requires significantly less volume of the power plant.

The disclosure includes a fuel processing system for desulfurization of a hydrocarbon fuel for a fuel cell power plant. The power plant has at least one fuel cell having an anode flow field and a cathode flow field disposed on opposed sides of an electrolyte. A supply of a hydrocarbon based hydrogen rich fuel is directed from a fuel source through a fuel inlet line into the anode flow field. The fuel processing system includes a fuel vaporizer, a reformer, a water gas shift reactor device, a preferential selective oxidizer device (the water gas shift reactor device and preferential selective oxidizer device may be collectively referred to as a carbon monoxide conversion station), all of which are secured in fluid communication through the fuel inlet line with the fuel source. The fuel processing system also includes a sulfur scrubber station that is secured in fluid communication with and downstream from the carbon monoxide conversion station for removing sulfur from the fuel passing through the sulfur scrubber station. The sulfur scrubber station includes an air inlet for selectively feeding air into the scrubber station.

The fuel processing system feeds the anode flow field of the fuel cell which is secured in fluid communication, through another extension of the fuel inlet line, with and downstream from the sulfur scrubber station so that the fuel flows from the sulfur scrubber station through the anode flow field.

By configuring the sulfur scrubber station to be downstream from the carbon monoxide conversion station the fuel entering the sulfur scrubber station has a minimal amount of carbon monoxide typically less than five parts per million (PPM). Therefore, as elemental sulfur is precipitated onto surfaces of sulfur adsorption material within the sulfur scrubber station, not enough carbon monoxide is available to form gaseous carbonyl sulfide. Any gaseous carbonyl sulfide would leave the scrubber station within the fuel stream and pass into the anode flow field to contaminate the fuel cell. Because no carbonyl sulfide is formed, the sulfur adsorption material within the scrubber station may adsorb a very substantial amount of elemental sulfur. For example, a preferred material in the sulfur scrubber station may be formed from a potassium-promoted activated carbon or other known sulfur selective carbons so that the sulfur adsorption material may adsorb as much elemental sulfur as between about 15 percent and about 60 percent of the weight of the material. In contrast, sulfur scrubbers of known desulfurizing systems have only been able to adsorb between about 0.5 to 1.0 percent sulfur.

Because such an enormous amount of sulfur may be removed from a fuel passing into the fuel cell, it is not necessary to regenerate the sulfur scrubber station. Instead, depending upon operational parameters of a particular fuel cell power plant, a sulfur adsorption material bed of a sulfur scrubber station of the present invention may simply be removed and replaced at predetermined intervals, if necessary. In a preferred embodiment of the system, the fuel is produced by a reformer and preferred fuels supplied to the reformer include methanol and ethanol.

Accordingly, it is a general purpose of the present disclosure to provide a fuel processing system and method for desulfurization of fuel for a fuel cell power plant that overcomes deficiencies of the prior art.

It is a more specific purpose to provide a fuel processing system and method for desulfurization of fuel for a fuel cell power plant that minimizes manufacturing, assembly and operating costs and displacement volume within the power plant.

These and other purposes and advantages of the present fuel processing system and method for desulfurization of fuel for a fuel cell power plant will become more readily apparent when the following description is read in conjunction with the accompanying drawing.

### BRIEF DESCRIPTION OF DRAWING

FIG. 1 is a simplified schematic representation of a fuel cell power plant including a fuel processing system constructed in accordance with the present disclosure.

### DESCRIPTION OF THE PREFERRED EMBODIMENTS

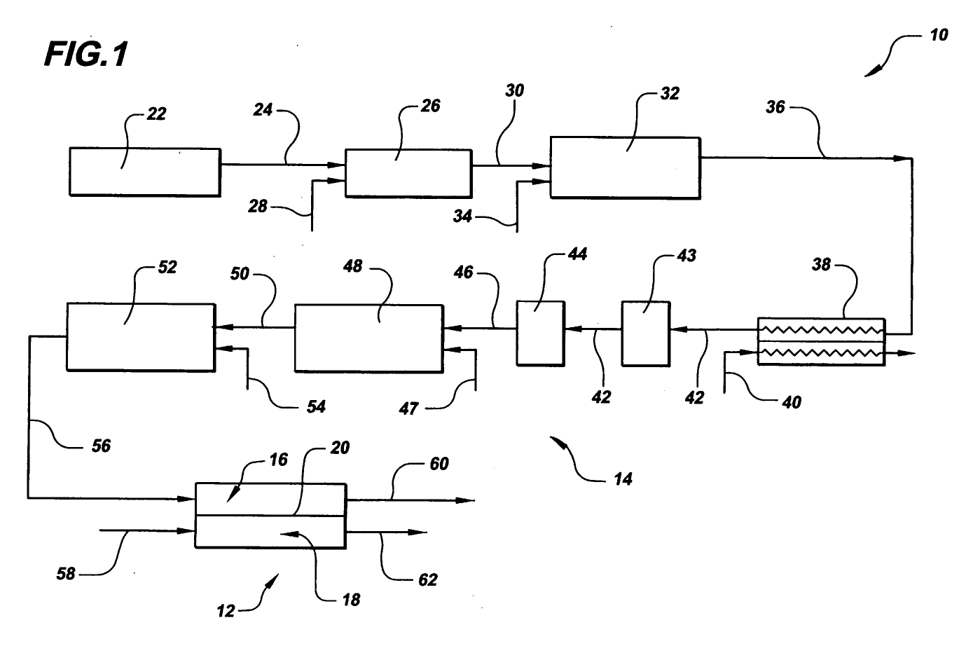

Referring to the drawings in detail, a fuel processing system for desulfurization of a hydrocarbon fuel for a fuel cell within a fuel cell power plant is shown in FIG. 1. The fuel cell power plant is generally designated by the reference numeral 10. The power plant 10 includes at least one fuel cell 12 as part of the fuel cell power plant 10, and the fuel cell 12 includes an anode flow field 16 and a cathode flow field 18 disposed on opposed sides of an electrolyte 20. The fuel processing system is generally designated by the reference numeral 14 in FIG. 1, and is described in more detail below as a system of the fuel cell power plant 10.

Within the power plant 10 a hydrocarbon based liquid fuel is stored in a fuel source 22 and may be selectively directed from the source 22 through a fuel inlet line 24 into and through the fuel processing system 14. The system 14 includes a fuel vaporizer 26 wherein a supply of steam 28 passing into the fuel vaporizer 26 vaporizes the fuel. The gaseous fuel then flows through a first extension 30 of the fuel inlet line 24 into a reformer 32 of the fuel processing system 14. The reformer 32 may receive a supply of air 34 and potentially more steam. The reformer 32 may be an auto-thermal reformer, a partial oxidation reformer, or any reformer means known in the art for transforming a hydrocarbon based fuel into a hydrogen gas (H₂) commonly called a reformate fuel stream. In addition to hydrogen, the reformation process also converts sulfur within the fuel stream into hydrogen sulfide (H₂S). The reformate stream may also include other gases, such as carbon monoxide, carbon dioxide, water, nitrogen, methane, ammonia and trace compounds. The reformate fuel stream is then directed to flow from the reformer 32 by a second extension 36 of the fuel inlet line 24 through a cooler/heat exchanger or exchangers 38 that receives a supply of coolant from a coolant inlet line 40 to control a temperature of the fuel stream within a desired range.

The fuel then moves from a third extension of the fuel inlet line 24 through a plurality of treatment stations. A first station may optionally be an ammonia removal station 43, which is not considered part of the fuel processing system 14 of the present invention. The fuel stream is then directed by an additional inlet line extension 42 through a carbon monoxide conversion station 45 which is part of the fuel processing system 14. The carbon monoxide conversion station 45 may include a water gas shift converter device 44, to lower carbon monoxide to about 0.5 to 1.0 percent, followed through inlet line extension 46 by a preferential selective oxidizer device 48, which includes air bleed line 47, for reducing the carbon monoxide level in the fuel stream to about five parts per million (PPM). Next, the fuel is directed by another extension 50 of the fuel inlet line 24 into and through a sulfur scrubber station 52 of the fuel processing system 14. The sulfur scrubber station 52 removes sulfur, typically in the form of hydrogen sulfide, from the fuel stream. The sulfur scrubber station 52 may be any sulfur scrubber station device or means for removing sulfur known in the art. Preferably the sulfur scrubber station or device 52 includes a bed containing potassium-promoted activated carbon or other known materials effective to promote the Claus reaction, such as Group 1 metals on a large surface area support material. The support materials and the bed within the sulfur scrubber station or device 52 are virtually the same as those described in the aforesaid U.S. Pat. No. 6,610,265 to Szydlowski et al. The materials are the U.S. Filter/Westates UOCH-KP carbon and sulfur selective carbon. Temperatures within the scrubber station 52 are maintained a few degrees above a dew point of the gas stream, about 170 degrees Fahrenheit or slightly higher, and about 0.5 percent oxygen is added to the fuel stream. The gaseous fuel passes over and through the sulfur scrubber station or device 52 and any of the aforesaid catalysts and, with the addition of a small amount of air through an air inlet 54. The Claus reaction causes gaseous hydrogen sulfide to react with oxygen and form elemental sulfur and water. The elemental sulfur is adsorbed on surfaces of carbon within the sulfur scrubber station or device 52. The fuel stream is then directed through a sixth extension 56 of the fuel inlet line 24 into the anode flow field 16 of the fuel cell 12. Simultaneously, a flow of an oxygen rich reactant stream, such as the air, is directed through an oxidant inlet line 58 through the cathode flow field 18 of the fuel cell 12 so as to produce electricity. An anode exhaust 60 and a cathode exhaust 62 are secured in fluid communication with the anode and cathode flow fields 16, 18 to direct the fuel and oxidant out of the fuel cell 12.

In a preferred embodiment, the fuel processing system 14, which includes the carbon monoxide conversion station 45 and the sulfur scrubber station 52, may be fed by the reformate gas stream from the reformer which is secured in fluid communication through the fuel inlet line 24 with the fuel source 22 so that the fuel directed into the fuel inlet line 24 from the reformer 32 is a reformate fuel stream. The carbon monoxide conversion station 45 is secured downstream from and in fluid communication with the reformer 32 and the carbon monoxide conversion station 45 is configured to direct flow of the fuel through the station 45 to convert carbon monoxide in the fuel to benign products, primarily carbon dioxide. The sulfur scrubber station 52 is secured in fluid communication with and downstream from the carbon monoxide conversion station 45. The sulfur scrubber station 52 also has an air inlet 54 and the sulfur scrubber station 52 is configured to direct the fuel through the station to remove sulfur from the fuel. The sulfur scrubber station is also configured to direct the fuel into the anode flow field 16 of the fuel cell 12 that is secured in fluid communication through the fuel inlet line 24 with and downstream from the sulfur scrubber station 52. Therefore, the fuel flows from the fuel source 22 through the fuel inlet line 24 to and through the reformer 32, to and through the carbon monoxide conversion station 45, to and through the sulfur scrubber station 52, and to and through the anode flow field 16 of the fuel cell 12.

The reformer means 32 may also be a sulfur tolerant reformer. The carbon monoxide conversion station 45 preferably leaves about five PPM or less carbon monoxide within the reformate fuel stream. Removal of virtually all of the carbon monoxide allows the sulfur scrubber station 52 to hold between about 15 percent and about 60 percent of the weight of the sulfur adsorption material within the sulfur scrubber station 52. Additionally the fuel stream entering the sulfur scrubber station 52 is controlled by the cooler 38, or by any other temperature control means (not shown) known in the art for controlling a temperature of a fuel stream within a fuel cell power plant, so that the temperature of the fuel stream within the sulfur scrubber station 52 is above the dew point of the fuel stream, and is also below a temperature at which hydrogen gas and oxygen gas within the fuel stream would ignite.

The disclosure also includes a method of desulfurization of fuel for a fuel cell power plant 10 by first reforming the fuel to produce a hydrogen rich reformate fuel stream containing sulfur compounds and to turn sulfur within the fuel into hydrogen sulfide; then, converting carbon monoxide from the reformate fuel stream passing through the fuel inlet line 24 from a fuel source 22 to an anode flow field 16 of a fuel cell 12 by flowing the reformed fuel through the carbon monoxide conversion station 45; then, removing sulfur from the fuel by passing the fuel through the sulfur scrubber station 52 while simultaneously flowing air through an air inlet 54 through the scrubber station 52; and, then directing flow of the fuel from the sulfur scrubber station 52 into and through the anode flow field 16 of the fuel cell 12.

In an additional preferred embodiment, preferred fuels include ethanol and methanol. In particular, ethanol is an increasingly popular and renewable fuel. Unfortunately, efficient removal of sulfur from ethanol at levels necessary for efficient operation of a fuel cell power plant has so far proven difficult and impractical. By the present disclosure, however, it is now possible to utilize either ethanol or methanol as fuels for a fuel cell power plant wherein the fuels are reformed by the reformer 32 into a hydrogen rich reactant stream containing sulfur and related contaminants described above. Through use of the present fuel processing system 14 with such fuels, it would no longer be necessary to utilize special dedicated fuel delivery systems to transport fuel from a point of origin to the fuel cell power plant 10 as is presently done to avoid contamination of ultra-pure, low sulfur content fuels. Additionally, the present fuel processing system 14 and method also efficiently removes sulfur from other common hydrogen rich hydrocarbon fuels such as gasoline, diesel fuel, natural gas, liquid petroleum gas (LPG_) etc.

In the present fuel processing system 14 and method of desulfurization of fuel for the fuel cell 12, within the sulfur scrubber station 52 any sulfur within the reactant fuel stream in the form of hydrogen sulfide is reacted with oxygen to form elemental sulfur and water. The elemental sulfur is then adsorbed in pores of sulfur adsorption material within the scrubber station 52. However, because any carbon monoxide has been removed from the reactant fuel stream prior to entry of the fuel into the sulfur scrubber station 52, virtually no gaseous carbonyl sulfide (COS) is formed from the elemental sulfur or other forms of sulfur within the sulfur scrubber station 52. This is important because COS has a negative effect on the performance of the fuel cell 12 and therefore the presence of COS must be avoided within the reformate fuel stream entering the fuel cell 12. The presence of carbon monoxide in the desulfurization station 52 also limits an ability of the sulfur scrubber station 52 to hold a significant weight percent of sulfur. If the fuel processing system 14 did not remove virtually all of the carbon monoxide, then much larger, or multiple desulfurizing beds would be required.

It is considered that part of the present disclosure is the discovery by the inventors herein that the formation of carbonyl sulfide within prior art desulfurization systems severely limited a holding capacity of the sulfur scrubber beds of prior art desulfurization systems or fuel processing systems. Instead of resolving that problem by complicated, parallel, on-off cycling sulfur scrubber beds, the present invention converts carbon monoxide to other benign species prior to removing sulfur so that carbonyl sulfide cannot be formed within the fuel. As a result, preferred sulfur adsorption materials within the sulfur scrubber station 52 may hold significantly more sulfur. A preferred sulfur adsorption material in the sulfur scrubber station 52 may be formed from a potassium-promoted activated carbon or other known sulfur selective carbons. Such sulfur adsorption materials as described above may adsorb as much elemental sulfur as between about 15 percent and about 60 percent of the weight of the sulfur adsorption material. (For purposes herein the word “about” is to mean plus or minus 10 percent.) In contrast, sulfur scrubbers of known fuel processing or desulfurizing systems have only been able to adsorb between about 0.5 to 1.0 percent.

While the present disclosure has been presented with respect to the described and illustrated fuel processing system 14 for desulfurization of fuel for a fuel cell power plant 10, it is to be understood that the disclosure is not to be limited to those alternatives and described embodiments. For example, the fuel processing system 14 may be utilized with any fuel cells including phosphoric acid fuel cells, proton exchange membrane fuel cells, etc. Accordingly, reference should be made primarily to the following claims rather than the forgoing description to determine the scope of the disclosure.

What is claimed is:

1. A fuel processing system (14) for a fuel cell power plant (10) operating on a sulfur containing fuel, the power plant (10) having at least one fuel cell (12) including an anode flow field (16) and a cathode flow field (18) disposed on opposed sides of an electrolyte (20), the fuel processing system (14) comprising:
a. a fuel vaporizer (26) secured in fluid communication through a fuel inlet line (24) with a fuel source (22);
b. a sulfur tolerant reformer (32) secured in fluid communication through an extension of the fuel inlet line (24) with the fuel vaporizer (26);
c. a carbon monoxide conversion station (45) secured in fluid communication through an extension of the fuel inlet line (24) with the reformer (32);
d. a sulfur scrubber station (52) secured in fluid communication, through an extension of the fuel inlet line (24), with and downstream from the carbon monoxide conversion station (45) for removing sulfur from the fuel passing through the sulfur scrubber station (52), the sulfur scrubber station (52) including an air inlet (54) for selectively permitting air into the scrubber station (52); and,
e. the anode flow field (16) of the fuel cell (12) being secured in fluid communication with and downstream from the sulfur scrubber station (52) through an additional extension of the fuel inlet line (24), so that fuel flows from the fuel source (22) through the fuel inlet line (24) sequentially to and through the fuel vaporizer (26), the reformer (32), the carbon monoxide conversion station (45), the sulfur scrubber station (52), and to and through the anode flow field (16) of the fuel cell (12).

2. The fuel processing system (14) of claim 1, wherein the carbon monoxide conversion station (45) comprises a water gas shift reactor device (44) in fluid communication with and upstream from a preferential selective oxidizer device (48) secured in fluid communication with the fuel inlet line (24).

3. The fuel processing system (14) of claim 1, wherein the fuel is selected from the group consisting of ethanol, methanol, gasoline, diesel fuel, natural gas, liquid petroleum gas (LPG) and combinations thereof.

4. The fuel processing system (14) of claim 1, wherein the sulfur scrubber station (52) includes sulfur adsorption material selected from the group consisting of potassium-promoted activated carbon, Group 1 metals on a support material, and other materials known to effect the Claus reaction.

5. A method of desulfurizing a hydrocarbon fuel for a fuel cell power plant (10), the power plant (10) having at least one fuel cell (12) including an anode flow field (16) and a cathode flow field (18) disposed on opposed sides of an electrolyte (20), the method comprising:
a. vaporizing the hydrocarbon fuel within a fuel vaporizer (26) secured in fluid communication through a fuel inlet line (24) with a fuel source (22);
b. supplying the vaporized fuel to a sulfur tolerant reformer (32);
c. reforming the vaporized fuel within the reformer (32) into a hydrogen rich gas stream containing hydrogen sulfide gas and carbon monoxide;
d. supplying the hydrogen rich gas stream containing the hydrogen sulfide gas and carbon monoxide to a carbon monoxide conversion station (45) and reducing the carbon monoxide content in the gas stream to less than five parts per million; and,
e. supplying the hydrogen rich, carbon monoxide reduced gas stream to a sulfur scrubber station (52) while also injecting air into the sulfur scrubber station (52) thereby converting the hydrogen sulfide in the gas stream into elemental sulfur and water.

6. The desulfurization method of claim 5, further comprising depositing the elemental sulfur from the gas stream on a sulfur adsorption material within the sulfur scrubber station (52) so that an amount of the deposited elemental sulfur held by the material as adsorbed sulfur is between about fifteen percent to about sixty percent of a weight of the sulfur adsorption material.

7. The desulfurization method of claim 5, further comprising replacing the sulfur adsorption material within the sulfur scrubber station (52) at predetermined intervals.
